(19) United States
(12) Patent Application Publication
(10) Pub. No.: US 2003/0076684 A1
(43) Pub. Date: Apr. 24, 2003

(54) Collapsible lampshade structure

(76) Inventor: Hsih Bin Chou, Huntington Beach, CA (US)

Correspondence Address: Wang & Lee, LLP, Attorneys at Law, Ste. 383, 17800 Castleton St., City of Industry, CA, 91748, US

(21) Appl. No.: 10/040,979

(22) Filed: Oct. 19, 2001

(51) Int. Cl. F21V 1/06

(52) U.S. Cl. 362/352; 362/357; 362/450

(57) ABSTRACT

The invention is a collapsible lampshade that helps conserve shipping and storage volume. Current invention consists of a rigid upper structures, a rigid lower structure, a flexible fabric joining the rigid upper structure and rigid lower structure, supported by several trapezoidal frames after the lampshade is assembled. Using trapezoidal frames to prop up the fabric, and hence completing the assembly process is easier and faster than other means of propping up and support the tension created by the fabric joining the rigid structures.

This invention hereby incorporates by reference the pending application number Ser. No. 09/803,555, filing date Mar. 12, 2001, by the same inventor: HSIH BIN CHOU.

### BACKGROUND OF THE INVENTION

Traditional lampshades are constructed from a rigid frame surrounded in fabric. The standard lamp shade is made from an upper ring and lower ring connected by rigid fabric or by flexible fabric held with supporting rods. The supporting rods usually accept a compression force. The flexible fabric usually accepts a tensile force. The construction of a lampshade having supporting rods requires the rods to be connected to the fabric. The fabric is sometimes sewn around the rod. Because the structure comprising the fabric, surrounding rods and frame are constructed as a unit, the lampshade requires substantial volume. The lampshade is also usually packaged in a transparent plastic bag, further adding volume.

One method of transporting lampshade requires stacking the lampshade. Unfortunately stacking is not possible when shipping individual lampshades. Lampshades stacked in bulk cannot be packaged with their respective lamps.

### SUMMARY OF THE INVENTION

The invention is a lampshade that collapses to conserve storage space. An upper structure such as a ring having fabric, ring, notches, and a lower structure connected by fabric, rings, are held apart by a number of basically trapezoid-shaped frames. When the trapezoidal frames are disassembled, the lampshade can collapse to become flat.

### BRIEF DESCRIPTION OF THE DRAWINGS

FIG. 1 is a diagram of the lampshade showing the basic elements

FIG. 2 is a close-up drawing of a notch located on the rigid upper structure

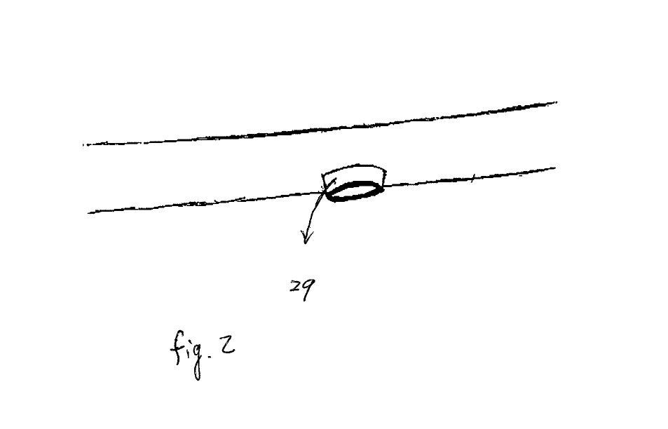

FIG. 3 is one embodiment of a trapezoidal frame.

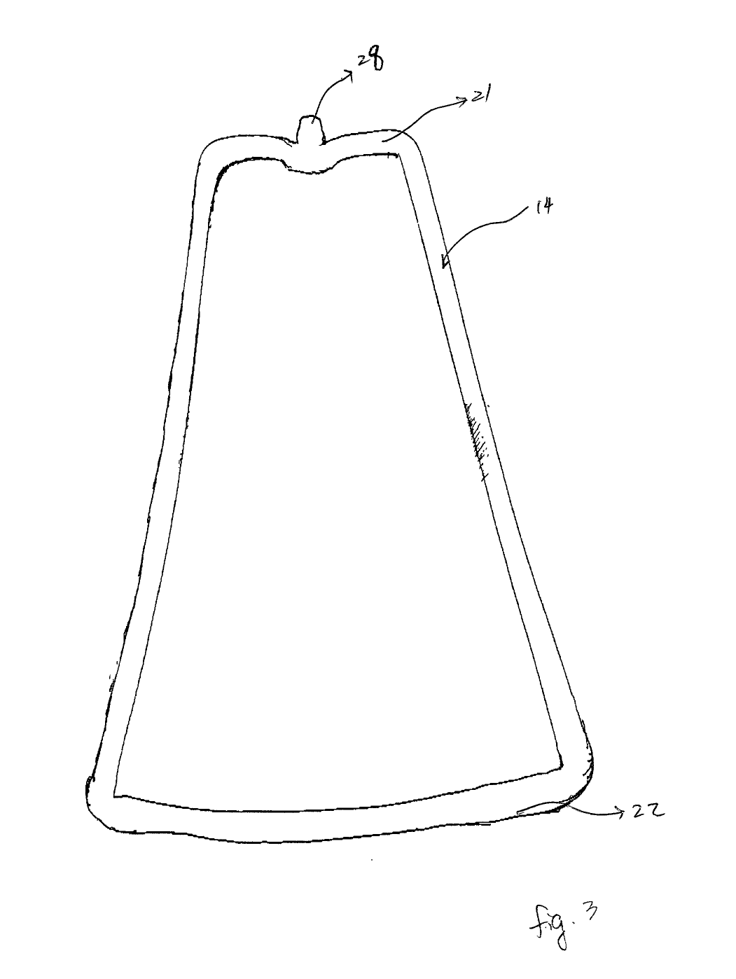

FIG. 4 is a cut-away drawing of current lamp shade showing one trapezoidal frame in assembled position.

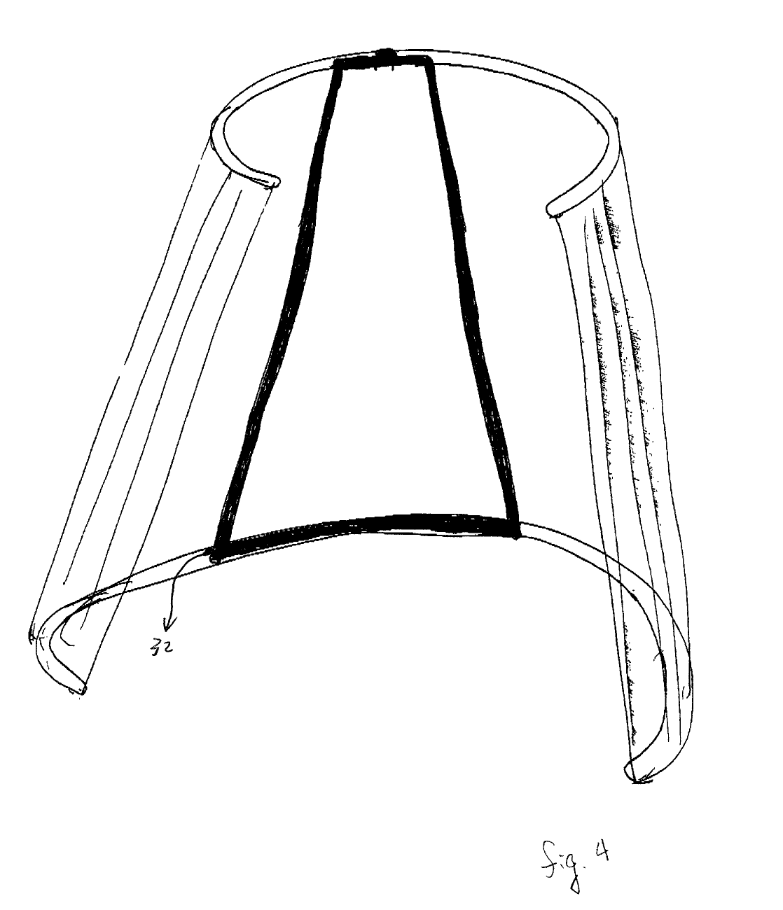

### DETAILED DESCRIPTION

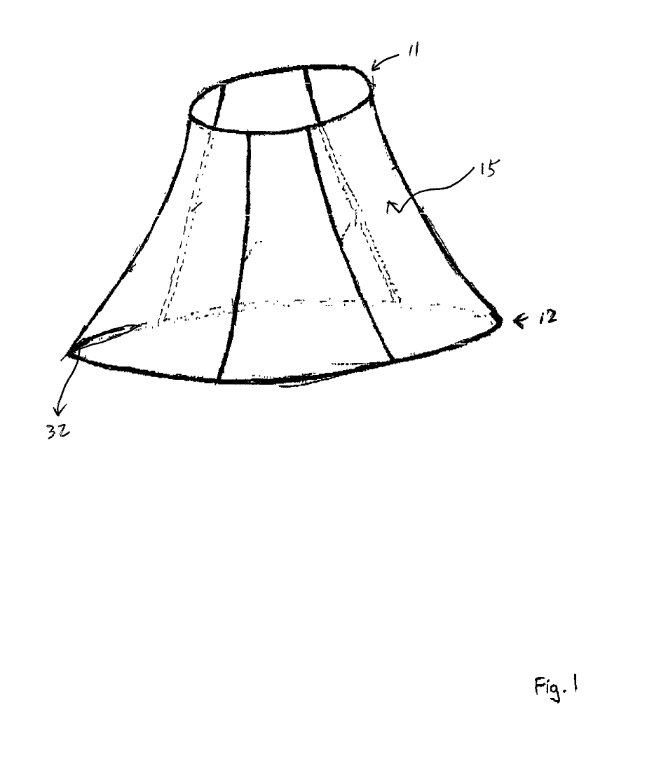

A collapsible lampshade can conserve shipping volume, and thus reducing cost of doing business. The preferred embodiment FIG. 1 is comprised of an upper rigid structure 11 connected to a lower rigid structure 12 by fabric 15 and supported by a plurality of basically trapezoidal frames 14.

When a lampshade is cylindrical in shape, the upper rigid structure 11 and lower rigid structure 12 are flat metal rings attached to the fabric 15 by wrapping the fabric circumferentially about the rigid rings 11, 12. The fabric can be sewn or glued around the ring allowing retention of the fabric in a direction perpendicular to the surface of the ring.

Supporting trapezoidal frame members 14 inserted between the upper rigid structure 11 and lower rigid structure 12 provides rigidity to the shade. The frames act as ribs accepting a compressive force against the tensile force of the lamp fabric. Sometimes the tensile force can flexibly bend the trapezoidal frames to allow various artistic designs. Such artistic bending depends on the rigidity of the material used, such as plastic, rubber or bamboo, in the trapezoidal frame members 14.

Assembly of the lampshade begins by opening the lampshade and separating the upper and lower rigid structures 11 and 12. In its preferred embodiment, the two rigid structures 11 and 12 would be joined together by fabric 15 already affixed to them.

The trapezoidal frames are then individually put into position to prop up the fabric 15 joining the two rigid structures 11 and 12. In the mid section of top parallel edge 21 of any trapezoidal frame 14, there is a dowel 28 pointing away from the frame 14. For each trapezoidal frame, insert dowel 28 into notch 29 located on the upper rigid structure 11. Insert bottom parallel edge 22 into the groove 32 located at the lower rigid structure.

Groove 32 for receiving bottom parallel edge 22 of any trapezoidal frames 14 can be formed by the gap between lower rigid structure 12 and the fabric 15 when they were joined by gluing, sewing or other means. Alternatively, groove 32 may also be formed by cutting away partial top portion along the circumferential length of lower rigid structure 12.

What is claimed is:

1. a collapsible lampshade comprising:
a. a rigid upper structure;
b. a rigid lower structure;
c. a flexible fabric joining said rigid upper structure with said rigid lower structure; and
d. a plurality of basically trapezoidal frames each having a top parallel edge and a bottom parallel edge, said top parallel edge and bottom parallel edge can be overlapingly joined to a partial section of the said rigid upper structure and rigid lower structure respectively when assembling the lamp shade.

2. The collapsible lampshade of claim 1, further comprising;
a. a plurality of notches on said rigid upper structure; and
b. a dowel in the mid section of each said top parallel edge, whereby users can insert the dowel into one of said notches when assembling the lamp shape.

3. The collapsible lampshade of claim 2, further comprising:
a. a pre-cut groove along the surface of said rigid lower structure, so that the bottom parallel edge of said basically trapezoidal frame can be easily secured when assembling the lamp shape.

4. The collapsible lampshade of claim 3 wherein the groove can be formed alternatively between the rigid lower structure and said fabric by any means of sewing, gluing or joining the fabric to the rigid lower structure

5. The collapsible lampshade of claim 1, wherein said lampshade is formed having a relatively cylindrical design, said rigid upper structure is formed as a circular ring, said lower structure is formed as a circular ring, said top and bottom parallel edges of said basically trapezoidal frames are arc-shaped to conform with said rigid ring-shaped upper and lower structures when joining said trapezoidal frames to said rigid upper and lower structures during assembly of the lamp shade.
